(19) United States
(12) Patent Application Publication
(10) Pub. No.: US 2008/0040796 A1
(43) Pub. Date: Feb. 14, 2008

(54) Electronic apparatus and authentication management method for electronic apparatus system

(76) Inventor: Nobuaki Takasu, Akishima-shi (JP)

Correspondence Address: KNOBBE MARTENS OLSON & BEAR LLP, 2040 MAIN STREET, FOURTEENTH FLOOR, IRVINE, CA, 92614, US

(21) Appl. No.: 11/784,795

(22) Filed: Apr. 10, 2007

(30) Foreign Application Priority Data
Apr. 27, 2006 (JP) 2006-123854

(51) Int. Cl. H04L 9/32

(52) U.S. Cl. 726/18

(57) ABSTRACT

According to one embodiment, an electronic apparatus includes a wireless communication unit, a wired communication unit, a password setting unit configured to acquire a password by using the wired communication unit, the password being used to limit execution of initial authentication to register wireless communication device authentication information required for wireless connection by the wireless communication unit, and to set the password, and an authentication management unit configured to request a request source device to transfer the password when the wired communication unit receives an execution request of the initial authentication after the password setting unit sets the password, and to execute the initial authentication when the password transferred in response to the request matches the password set by the password setting unit.

### CROSS-REFERENCE TO RELATED APPLICATIONS

This application is based upon and claims the benefit of priority from Japanese Patent Application No. 2006-123854, filed Apr. 27, 2006, the entire contents of which are incorporated herein by reference.

### BACKGROUND

1. Field

One embodiment of the invention relates to an authentication management technique for an electronic apparatus system in which wireless communication complying with, e.g., the Wireless USB standard is performed between an electronic apparatus and a peripheral device.

2. Description of the Related Art

In recent years, a battery-powered portable electronic apparatus such as a notebook personal computer has widely prevailed. Generally, this type of electronic apparatus can connect to various types of peripheral devices as needed.

Recently, the electronic apparatus (main device) also wirelessly connects to the peripheral device without a cable. Accordingly, various types of techniques for causing a user to easily manage invisible wireless connections have been proposed (e.g., see Jpn. Pat. Appln. KOKAI Publication No. 2002 152816).

For example, in order to safely establish wireless connection complying with the Wireless USB standard, initial authentication is executed only when the electronic apparatus connects to the peripheral device via a cable. This prevents many unspecified partners from wireless connection.

However, as long as an electronic apparatus of an unauthorized user connects to the peripheral device via the cable, the unauthorized user can execute initial authentication between his/her electronic apparatus and the target peripheral device, and illicitly use the target peripheral device by wireless connection at any time. This is why initial authentication must be appropriately managed.

### BRIEF DESCRIPTION OF THE SEVERAL VIEWS OF THE DRAWINGS

A general architecture that implements the various feature of the invention will now be described with reference to the drawings. The drawings and the associated descriptions are provided to illustrate embodiments of the invention and not to limit the scope of the invention.

FIG. 1 is an exemplary block diagram showing the connection form of an electronic apparatus system according to an embodiment of the present invention;

FIG. 2 is an exemplary block diagram showing a wired connection form between an electronic apparatus and a wireless peripheral device for executing initial authentication required for wireless communication in the electronic apparatus system according to the embodiment;

FIG. 3 is an exemplary block diagram schematically showing the electronic apparatus in the electronic apparatus system according to the embodiment;

FIG. 4 is an exemplary block diagram schematically showing the wireless peripheral device in the electronic apparatus system according to the embodiment;

FIG. 5 is a view exemplifying the first administrator authentication management window displayed by authentication management software which operates on the electronic apparatus in the electronic apparatus system according to the embodiment;

FIG. 6 is a view exemplifying authentication information held by the wireless peripheral device in the electronic apparatus system according to the embodiment;

FIG. 7 is a view exemplifying a general user authentication management window displayed by the authentication management software which operates on the electronic apparatus in the electronic apparatus system according to the embodiment;

FIG. 8 is a view exemplifying the second administrator authentication management window displayed by the authentication management software which operates on the electronic apparatus in the electronic apparatus system according to the embodiment;

FIG. 9 is a view exemplifying the third administrator authentication management window displayed by the authentication management software which operates on the electronic apparatus in the electronic apparatus system according to the embodiment;

FIG. 10 is an exemplary flowchart showing an authentication management sequence executed by the authentication management software operating on the electronic apparatus in the electronic apparatus system and set with an administrator authority level according to the embodiment;

FIG. 11 is an exemplary flowchart showing an authentication management sequence executed by the authentication management software operating on the electronic apparatus in the electronic apparatus system and set with a general user authority level according to the embodiment; and

FIG. 12 is an exemplary flowchart showing an authentication management sequence executed by authentication management firmware operating on the wireless peripheral device in the electronic apparatus system according to the embodiment.

### DETAILED DESCRIPTION

Various embodiments according to the invention will be described hereinafter with reference to the accompanying drawings. In general, according to one embodiment of the invention, an electronic apparatus includes a wireless communication unit, a wired communication unit, a password setting unit configured to acquire a password by using the wired communication unit, the password being used to limit execution of initial authentication to register wireless communication device authentication information required for wireless connection by the wireless communication unit, and to set the password, and an authentication management unit configured to request a request source device to transfer the password when the wired communication unit receives an execution request of the initial authentication after the password setting unit sets the password, and to execute the initial authentication when the password transferred in response to the request matches the password set by the password setting unit.

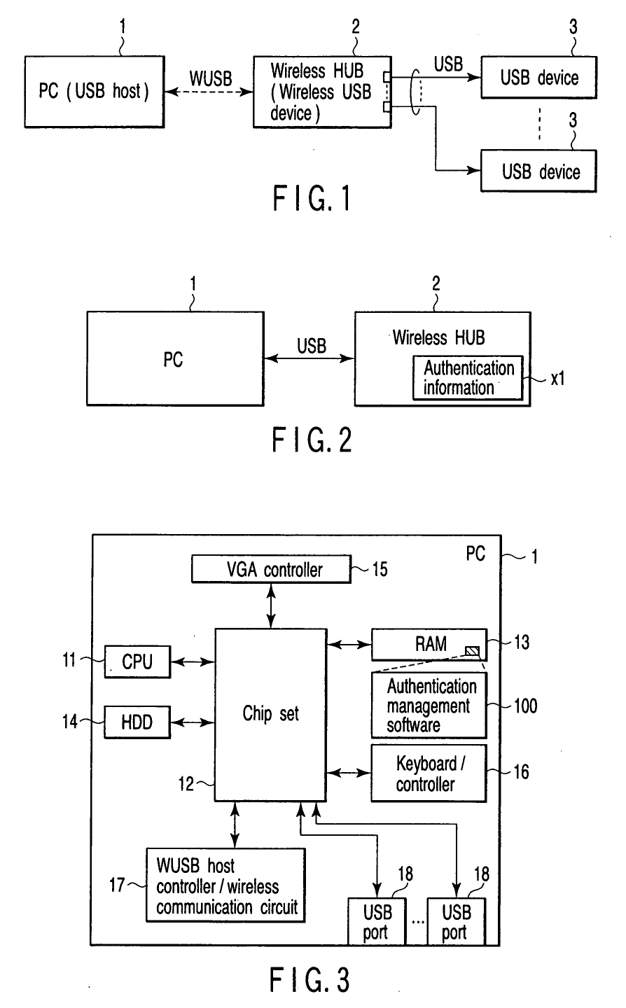

FIG. 1 is an exemplary block diagram showing the connection form of an electronic apparatus system according to an embodiment of the present invention. In the present invention, the first electronic apparatus (peripheral device) serves as a wireless hub 2, and the second electronic apparatus (main device) serves as a personal computer (PC) 1.

The PC 1 serves as, e.g., a battery drivable notebook computer which is used by itself while a user is outing or on the move, and wirelessly connected to the wireless hub 2 by a sequence complying with the Wireless USB (WUSB) standard as needed, e.g., when the user is in an office. Various types of USB devices 3 such as a hard disk drive (HDD) and printer are connected to the wireless hub 2 via wire by a sequence complying with the USB standard, such that the PC 1 wirelessly connected to the wireless hub 2 can freely use the USB devices 3 via the wireless hub 2.

In order to perform wireless data communication complying with the WUSB standard between the PC 1 and the wireless hub 2, i.e., in order to establish wireless connection between them, the PC 1 and the wireless hub 2 need to recognize each other as authorized wireless connection partners in advance. Hence, initial authentication is required, and as shown in FIG. 2, the PC 1 and the wireless hub 2 are connected via wire by the sequence complying with the USB standard for initial authentication. Upon execution of initial authentication, for example, the wireless hub 2 registers authentication information x1 indicating that the PC 1 is an authorized wireless connection partner. After the wireless hub 2 registers it, the PC 1 can always execute wireless data communication complying with the WUSB standard with the wireless hub 2.

As described above, various types of USB devices 3 can connect to the wireless hub 2. Hence, it is not preferable that the wireless hub 2 wirelessly connects to many unspecified partners. More specifically, it is not preferable that the wireless hub 2 recognizes any USB device as an authorized partner of initial authentication as long as the USB device connects to the wireless hub 2 via wire. To cope with this problem, the electronic apparatus system according to this embodiment can limit partners which can execute initial authentication with the wireless hub 2. This point will be described below.

FIG. 3 is an exemplary block diagram showing the arrangement of the PC 1. Referring to FIG. 3, the PC 1 includes a CPU 11, a chipset 12, a RAM 13, a hard disk drive (HDD) 14, a VGA controller 15, a keyboard controller 16, a WUSB host controller/wireless communication circuit 17, and a plurality of USB ports 18.

The CPU 11 serves as a processor which controls operation of the PC 1 as a whole, and executes various programs loaded from the HDD 14 and stored in the memory 13. Authentication management software 100 (to be described later) is one of these programs. The chipset 12 serves as a bridge device which connects modules in the PC 1. The chipset 12 has an I/O controller function of controlling access to each module.

The RAM 13 is a memory device serving as a main memory of the PC 1, and stores various programs to be executed by the CPU 11 and data to be used by these programs. The HDD 14 is a storage device serving as an external memory of the PC 1, and stores many programs and data, as an auxiliary device of the RAM 13.

The VGA controller 15 is a device operating on the output side of a user interface of the PC 1, and controls to display, on a display device such as an LCD, image data generated by the CPU 11. The keyboard controller 16 is a device operating on the input side of the user interface of the PC 1, and transmits, to the CPU 11, operation content data input from a keyboard or mouse.

The WUSB host controller/wireless communication circuit 17 controls the PC 1 to function as a USB host, and also controls wireless communication with the USB device (in this case, the wireless hub 2). In the USB standard, N USB devices are connected to one USB host serving as a base in a tree structure, and this USB host serving as the base of the tree structure manages all the USB devices. The USB devices each transmit/receive data to/from the USB host, but do not transmit/receive data to/from each other.

Each USB port 18 is a terminal unit used to connect one end of a cable whose other end is connected to the wireless hub 2 when executing initial authentication. The USB device 3 can also be directly connected to the PC 1 by wire via the USB port 18 (without the wireless hub 2).

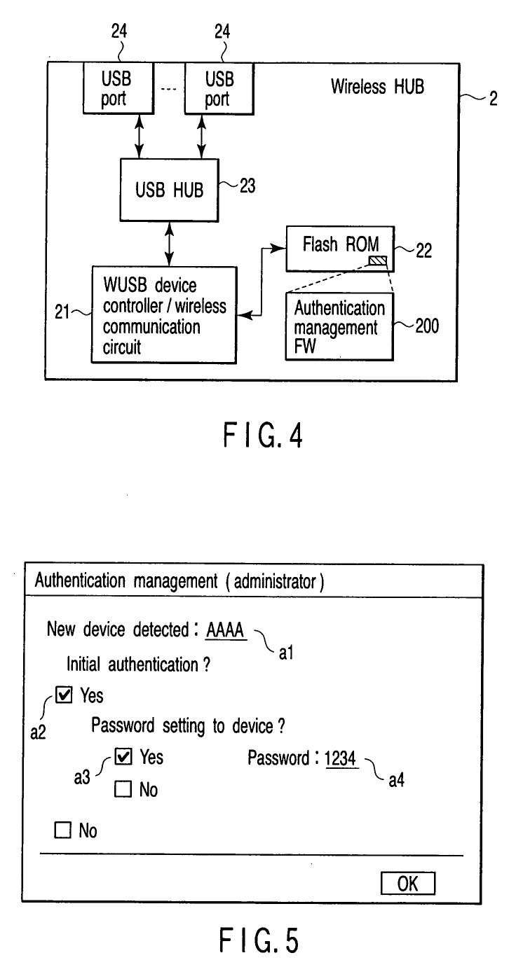

FIG. 4 is an exemplary block diagram showing the arrangement of the wireless hub 2. Referring to FIG. 4, the wireless hub 2 includes a WUSB device controller/wireless communication circuit 21, a flash ROM 22, a USB hub 23, and a plurality of USB ports.

The WUSB device controller/wireless communication circuit 21 controls the wireless hub 2 to function as the USB device, and also controls wireless communication with the USB host (in this case, the PC 1). The WUSB device controller/wireless communication circuit 21 has a processor function of executing various programs stored in the flash ROM 22.

The flash ROM 22 is a memory device which stores authentication management firmware 200 (to be described later) in an electrically rewritable manner. The authentication management firmware 200 comprises a program to be executed by the WUSB device controller/wireless communication circuit 21.

The USB hub 23 is a bridge device used to connect the plurality of USB devices (in this case, the USB devices 3) connected to the wireless hub 2 by wire via USB ports 24, and the USB host (in this case, the PC 1) wirelessly connected to the wireless hub 2 via the WUSB device controller/wireless communication circuit 21. Each USB port 24 is a terminal unit used to connect one end of a cable whose other end is connected to the USB device 3.

When the PC 1 and wireless hub 2 having the above described arrangements are connected via their USB ports, the chipset 12 detects establishment of this connection on the PC 1 side. The authentication management software 100 has requested the chipset 12 to notify this detection in advance. Hence, upon reception of this notification, the authentication management software 100 first displays an authentication management window shown in FIG. 5.

The authentication management software 100 can set two authority levels, i.e., administrator and general user authority levels. The authentication management software 100 operating on the PC 1 is set with the administrator authority level. The authentication management window displayed by the authentication management software 100 set with the administrator authority level includes an area a1 used to display the identification information of a newly detected USB device, a check box a2 used to input an instruction to execute initial authentication for wireless connection, a check box a3 used to input an instruction to set a password, and an area a4 used to input the password. “AAAA” in the display area a1 is identification information of the connected wireless hub 2. For example, information such as a MAC address unique to the wireless hub 2 is displayed.

When the check box a2 is checked, and the check box a3 is checked and the password is input in the input area a4 on the authentication management window, the authentication management software 100 causes the WUSB host controller/wireless communication circuit 17 to execute initial authentication with the wireless hub 2, transfers the input password to the wireless hub 2, and instructs the wireless hub 2 to set it. In this case, the WUSB host controller/wireless communication circuit 17 executes initial authentication by wired communication via the USB port 18 without wireless communication.

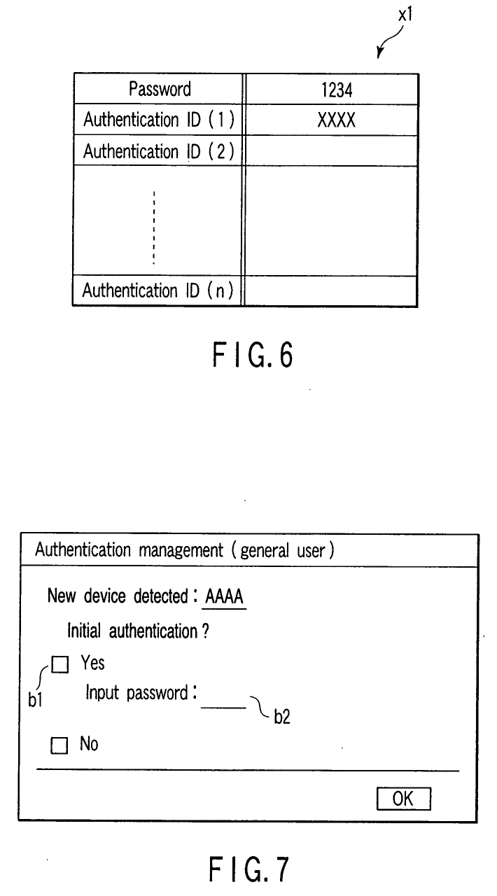

When executing initial authentication with the PC 1, as shown in FIG. 6, the authentication management firmware 200 on the wireless hub 2 side registers identification information of the PC 1 as the identification information x1. “XXXX” in an authentication ID (1) column is the identification information of the PC 1. Upon reception of the password from the PC 1 in initial authentication, the authentication management firmware 200 also registers this password as the authentication information x1. Referring to FIG. 6, the authentication management firmware 200 registers an input password “1234” input on the authentication management window on the PC 1 side as shown in FIG. 5. After that, when executing initial authentication, the authentication management firmware 200 requests the partner (PC 1) to transfer the password. The flash ROM 22 assures an area to store the authentication information x1.

Upon completion of initial authentication, the PC 1 can perform wireless communication with the wireless hub 2. Assume that a PC other than the PC 1 is connected to the wireless hub 2 via wire. Authentication management software 100 operating on the connected PC is set with a general user authority level.

Upon reception of notification from a chipset 12 that connection with the wireless hub 2 is detected, the authentication management software 100 set with the general user authority level displays the authentication management window shown in FIG. 7. Referring to FIG. 7, the authentication management window displayed by the authentication management software 100 set with the general user authority level does not include a password setting check box and the like. When executing initial authentication with the wireless hub 2, a check box b1 is checked, and the password obtained from an administrator is input in an input area b2. When no password is set to the wireless hub 2, the input area b2 may be left blank.

As described above, the authentication management software 100 causes a WUSB host controller/wireless communication circuit 17 to execute initial authentication with the wireless hub 2. When a password is set, the authentication management software 100 transfers the password input in the input area b2 in response to a password transfer request from the wireless hub 2 side. Upon reception of this password, an authentication management firmware 200 in the wireless hub 2 executes initial authentication when the passwords matches, and additionally registers the PC identification information as authentication information x1. In other words, even when an unauthorized user who does not know the password can connect his/her PC to the wireless hub 2 via wire, initial authentication is prevented.

As described above, in the electronic apparatus system according to this embodiment, the USB host (PC 1) side has a mechanism for setting a password used to limit authorized partners which can execute initial authentication with the wireless USB device. The wireless USB device (wireless hub 2) side has a mechanism for determining whether the initial authentication partner is an authorized partner by using the password received from the USB host. As a result, the electronic apparatus system can appropriately manage initial authentication for wireless connection between the USB host and the wireless USB device.

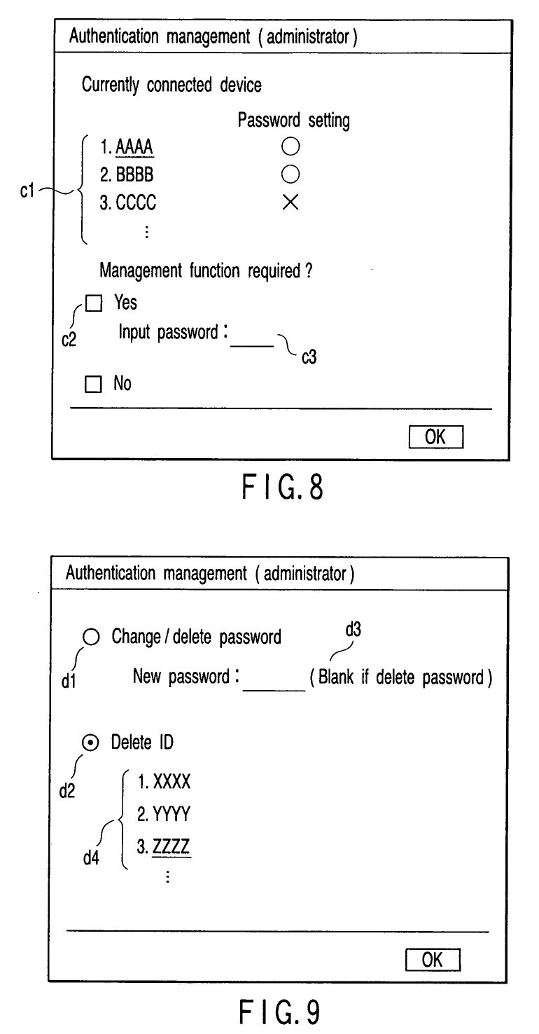

The authentication management software 100 set with the administrator authority level also has a function of maintaining initial authentication with the wireless USB device which has undergone initial authentication with a plurality of partners. To implement this function, the authentication management software 100 displays an authentication management window shown in FIG. 8 as needed.

The authentication management window displays a list c1 of the wireless USB devices (including the wireless hub 2) as choices which are connected to the PC 1 by wire via USB ports 18. Only the listed wireless USB devices can be selected as maintenance targets, and this maintenance function is effective only in wired connection. Additionally, this list presents information indicating the presence/absence of password setting for each wireless USB device.

In order to select a desired wireless USB device from the displayed list to execute a maintenance operation, a check box c2 is checked, and a password is input in an input area c3 if the password is set. The authentication management software 100 transfers the input password to the selected wireless USB device. Upon reception of a response message indicating that the passwords match, the authentication management software 100 displays the authentication management window shown in FIG. 9. At this time, the authentication management software 100 receives all pieces of identification information of the selected wireless USB devices which have undergone initial authentication.

This authentication management window includes buttons d1 and d2 used to change/delete the password or delete the identification information of the wireless hub device selected in FIG. 8. When changing/deleting the password by selecting the button d1, a new password is input (if the password is to be deleted, no password is input) in an input area d3. For example, when changing the password, the authentication management software 100 transfers, to the wireless USB device, a password change instruction which contains a new password input in the input area d3. Upon reception of this instruction, the wireless USB device updates the password registered as the authentication information x1 to the transferred new password.

When deleting the identification information by selecting the button d2, the identification information of the partner which has undergone initial authentication is selected from a displayed list d4. The authentication management software 100 transfers, to the wireless USB device, an identification information deleting instruction which contains the selected identification information. Upon reception of this instruction, the Wireless USB device deletes this identification information registered as the authentication information x1.

As described above, the electronic apparatus system according to this embodiment can change the password which has been set in the wireless USB device, and delete the identification information of the partner which has undergone initial authentication. Hence, the password can be appropriately protected from leakage and the like.

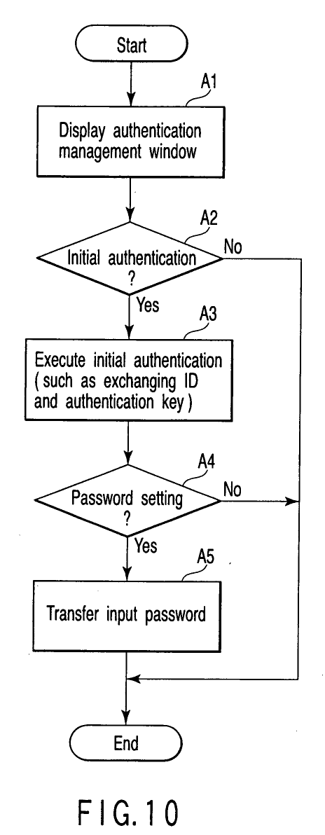

An authentication management operation sequence executed by the electronic apparatus system according to this embodiment will be described next with reference to the flowcharts in FIGS. 10 to 12.

FIG. 10 is an exemplary flowchart showing an authentication management sequence to be executed by the authentication management software 100 operating on the PC 1 and set with an administration authority level.

When the wireless hub 2 is connected to the PC 1 by wire via the USB port 18, the authentication management software 100 displays the authentication management window (FIG. 5) for initial authentication, which includes the check box for determining the presence/absence of password setting (block A1). When initial authentication is instructed to be executed on this authentication management window (YES in block A2), the authentication management software 100 causes the WUSB host controller/wireless communication circuit 17 to execute initial authentication such as exchanging the identification information and an authentication key (block A3).

When password setting is instructed (YES in block A4), the authentication management software 100 transfers, to the wireless hub 2, the password setting instruction which contains the password input on the authentication management window (block A5).

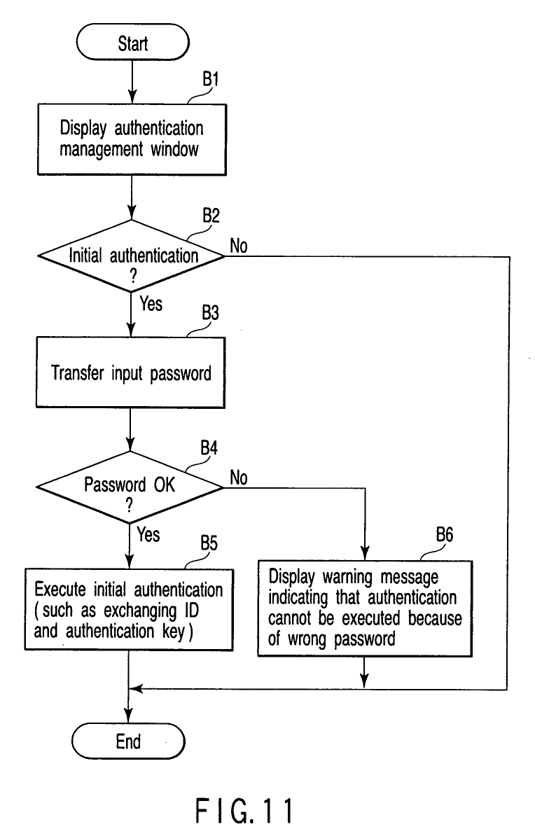

FIG. 11 is an exemplary flowchart showing the authentication management sequence to be executed by the authentication management software 100 operating on the PC 1 and set with the general user authority level.

When the wireless hub 2 is connected to the PC 1 by wire via the USB port 18, the authentication management software 100 displays the authentication management window (FIG. 7) for initial authentication, which includes no check box for determining the presence/absence of password setting (block B1). When initial authentication is instructed to be executed on the authentication management window (YES in block B2), the authentication management software 100 transfers, to the wireless hub 2, the password input on the authentication management window (block B3).

Upon reception a response message indicating that the passwords match (YES in block B4), the authentication management software 100 causes the WUSB device controller/wireless communication circuit 17 to execute initial authentication such as exchanging the identification information and authentication key (block B5). On the other hand, upon reception of a response message indicating that the passwords do not match (NO in block B4), the authentication management software 100 displays a warning message indicating that initial authentication cannot be executed since the input password is not correct (block B6).

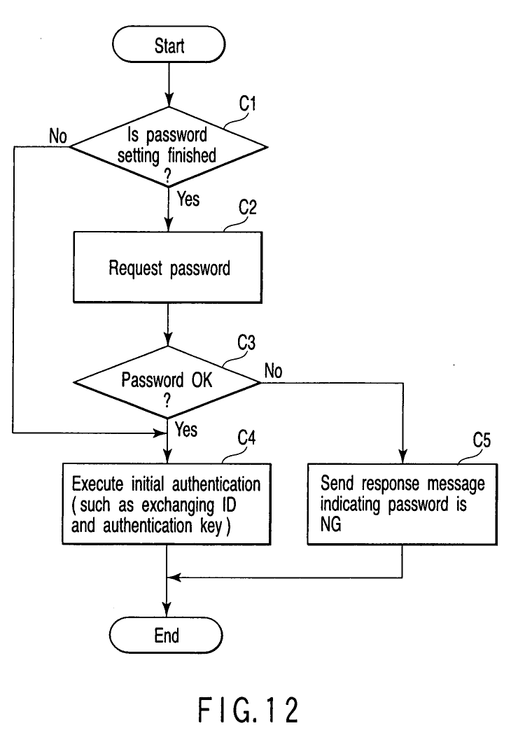

FIG. 12 is an exemplary flowchart showing the authentication management sequence to be executed by the authentication management firmware 200 in the wireless hub 2.

When the PC 1 is connected to the wireless hub 2 by wire via the USB port 24 and requests to execute initial authentication, the authentication management firmware 200 checks a password is already set (block C1). If a password is already set (YES in block C1), the authentication management firmware 200 requires the PC 1 to transfer the password (block C2).

When the password returned in response to this request matches the set password (YES in block C3), the authentication management firmware 200 causes the WUSB device controller/wireless communication circuit 21 to execute initial authentication such as exchanging the identification information and authentication key (block C4). On the other hand, if these passwords do not match (NO in block C3), the authentication management firmware 200 transmits, to the PC 1, a response message indicating that the transferred password is not correct (block C5), and then the process ends without initial authentication.

In the above description, the pieces of identification information of the partners which have undergone initial authentication are listed and displayed by the maintenance function provided from the authentication management software 100 set with the administrator authority level. However, to simplify the identification information deleting operation, a unique name such as a mnemonic code may be effectively registered in correspondence with the identification information. The authentication management firmware 200 of each wireless hub 2 also manages this name as the authentication information x1. When displaying the list of the identification information of the partners which have undergone initial authentication, the authentication management software 100 displays a list of the names registered separately. When the names arbitrarily registered by the administrator are listed and displayed, a human error can be prevented in comparison with when displaying a list of MAC addresses and the like.

For example, the authentication management software 100 can also effectively set a maximum number of pieces of identification information capable of being registered in initial authentication. Upon this setting, the authentication management firmware 200 prevents execution of initial authentication when the number of pieces of registered information reaches the maximum number. When the maximum number is 1, the authentication management firmware 200 can prevent execution of initial authentication with a partner other than the PC 1 itself. That is, the authentication management firmware 200 wirelessly communicates only with the PC 1 itself.

While certain embodiments of the inventions have been described, these embodiments have been presented by way of example only, and are not intended to limit the scope of the inventions. Indeed, the novel methods and systems described herein may be embodied in a variety of other forms; furthermore, various omissions, substitutions and changes in the form of the methods and systems described herein may be made without departing from the spirit of the inventions. The accompanying claims and their equivalents are intended to cover such forms or modifications as would fall within the scope and spirit of the inventions.

What is claimed is:

1. An electronic apparatus comprising:
a wireless communication unit;
a wired communication unit;
a password setting unit configured to acquire a password by using the wired communication unit, the password being used to limit execution of initial authentication to register wireless communication device authentication information required for wireless connection by the wireless communication unit, and to set the password; and
an authentication management unit configured to request a request source device to transfer the password when the wired communication unit receives an execution request of the initial authentication after the password setting unit sets the password, and to execute the initial authentication when the password transferred in response to the request matches the password set by the password setting unit.

2. The electronic apparatus according to claim 1, wherein the authentication management unit receives a request, by using the wired communication unit, to delete the authentication information registered in the initial authentication and deletes the requested authentication information under a condition that the password is transferred if the password setting unit sets the password.

3. The electronic apparatus according to claim 1, wherein the authentication management unit receives a request, by using the wired communication unit, to set the number of pieces of authentication information capable of being registered in the initial authentication and sets the requested number of pieces of authentication information capable of being registered under a condition that the password is transferred if the password setting unit sets the password.

4. The electronic apparatus according to claim 3, wherein the authentication management unit prevents execution of the initial authentication with the new partner and fixes a wireless communication partner, when the number of pieces of authentication information registered in the initial authentication reaches the set number of pieces of information capable of being registered.

5. The electronic apparatus according to claim 1, wherein the authentication management unit receives a request, by using the wired communication unit, to supply a name corresponding to the authentication information registered in the initial authentication and manages the name in correspondence with the authentication information under a condition that the password is transferred if the password setting unit sets the password.

6. An electronic apparatus comprising:
a wireless communication unit;
a wired communication unit;
a input unit; and
an authentication management unit configured to input a password by using the input unit, the password being used to limit execution of initial authentication to register wireless communication device authentication information required for wireless connection by another electronic apparatus wirelessly connected by the wired communication unit, and to transfer, by using the wired communication unit, the password to the other electronic apparatus to set the password.

7. The electronic apparatus according to claim 6, wherein the authentication management unit becomes effective only in wired communication performed by the wired communication unit.

8. The electronic apparatus according to claim 6, wherein the authentication management unit transfers the password, by using the wired communication unit, to the other electronic apparatus and notifies to the other electronic apparatus of a request, by using the wired communication unit, to delete authentication information registered by the other electronic apparatus in the initial authentication, when the password is set.

9. The electronic apparatus according to claim 6, wherein the authentication management unit transfers the password, by using the wired communication unit, to the other electronic apparatus and notifies the other electronic apparatus of a request, by using the wired communication unit, to set the number of pieces of authentication information capable of being registered in the initial authentication, when the password is set.

10. The electronic apparatus according to claim 6, wherein the authentication management unit transfers the password, by using the wired communication unit, to the other electronic apparatus and transfers a name, by using the wired communication unit, to be supplied to the authentication information registered by the other electronic apparatus in the initial authentication and manage the name in correspondence with the authentication information, when the password is set.

11. An authentication management method for an electronic apparatus system in which a main device and a peripheral device are connected via one of a wireless communication path and a wired communication path, the method comprising:
inputting a password used to limit execution of initial authentication by the peripheral device to register wireless communication device authentication information required for wireless connection, by the main device;
transferring the input password to the peripheral device via the wired communication path, by the main device;
setting the transferred password, by the peripheral device; and
requesting a request source device to transfer the password when a request to execute the initial authentication is received via the wired communication path after the password is set, and executing the initial authentication when the password transferred in response to the request matches the set password, by the peripheral device.
